(19) United States
(12) Patent Application Publication
(10) Pub. No.: US 2014/0244484 A1
(43) Pub. Date: Aug. 28, 2014

(54) NETWORK COMPUTING ENVIRONMENT COLLECTION AND NOTIFICATION OF POINT OF SALE INFORMATION

(71) Applicant: INTERNATIONAL BUSINESS MACHINES CORPORATION, Armonk, NY (US)

(72) Inventors: Gregory J. Boss, Saginaw, MI (US); Andrew R. Jones, Round Rock, TX (US); C. Steven Lingafelt, Durham, NC (US); Kevin C. McConnell, Austin, TX (US); John E. Moore, Jr., Brownsburg, IN (US)

(73) Assignee: INTERNATIONAL BUSINESS MACHINES CORPORATION, Armonk, NY (US)

(21) Appl. No.: 13/779,867

(22) Filed: Feb. 28, 2013

(51) Int. Cl. G06Q 30/00

(52) U.S. Cl. CPC G06Q 30/016
USPC 705/39

(57) ABSTRACT

Automated information collection and notification ancillary to the acquisition of a product or service includes determining transaction and information thresholds for application to attributes of a transaction for goods or services, a card account used to purchase an item or service pursuant to the transaction and associated with application of the thresholds. When the purchase of the item or service is accomplished, additional informational items to be retained are determined in response to an attribute of the additional informational items meeting the information threshold, an attribute of the transaction meeting the transaction threshold, and execution of the transaction via the identified card account. Authoritative source locations for retrieval of copies of the additional information, and ancillary storage devices for holding copies of or links to the additional information items, are identified.

### FIELD OF THE INVENTION

The present invention generally relates to the automated collection, notification and provision of information within a network computing environment that is ancillary to acquisition of a product or service.

### BACKGROUND

When goods or services are sold or exchanged in a commercial transaction, in addition to the physical transfer of the good or the performance of the service, it is common to generate and transfer associated receipts, bills of sale, instruction booklets and manuals, and other ancillary information having tangible or physical attributes or form. Some ancillary information is generated after the transaction, including product recalls, manual updates, changes in product performance specifications or requirements or warranty information, and still other examples will be apparent to one skilled in the art. Organizing, maintaining and distributing all of such various ancillary information items may be challenging. It is not always apparent which item may be important and needed in the future, and accordingly care may not be taken to store or track certain items that are later needed. Accordingly, an end user or consumer may fail to find desired items, or to receive notice of information that may be created or distributed subsequent to the transaction.

### BRIEF SUMMARY

In one aspect of the present invention, a method for automated information collection and notification ancillary to the acquisition of a product or service includes a processing unit determining transaction and information thresholds for application to attributes of a transaction for goods or services. The processing unit also identifies a card account used to purchase an item or service pursuant to the transaction and that is associated with application of the transaction and information thresholds. The processing unit determines additional informational items to be retained when the purchase of the item or service is accomplished, in response to an attribute of the additional informational items meeting the information threshold, an attribute of the transaction meeting the transaction threshold, and execution of the transaction via the identified card account. The processing unit identifies an authoritative source location for retrieval of copies of the additional information that has the attribute meeting the information threshold, wherein the authoritative source location is hosted by a remote device in communication with the processing unit via a network computing environment. The processing unit also identifies an ancillary storage device for holding copies of the additional information items that are retrieved from the authoritative source location via the network computing environment, or a link to the authoritative source location via the network computing environment. The ancillary storage device is a local device in circuit communication with the processing unit, or a remote device in communication with the processing unit via the network computing environment.

In another aspect, a system has a processing unit, computer readable memory and a tangible computer-readable storage medium with program instructions, wherein the processing unit, when executing the stored program instructions determines transaction and information thresholds for application to attributes of a transaction for goods or services. The processing unit also identifies a card account used to purchase an item or service pursuant to the transaction and that is associated with application of the transaction and information thresholds. The processing unit determines additional informational items to be retained when the purchase of the item or service is accomplished, in response to an attribute of the additional informational items meeting the information threshold, an attribute of the transaction meeting the transaction threshold, and execution of the transaction via the identified card account. The processing unit identifies an authoritative source location for retrieval of copies of the additional information that has the attribute meeting the information threshold, wherein the authoritative source location is hosted by a remote device in communication with the processing unit via a network computing environment. The processing unit also identifies an ancillary storage device for holding copies of the additional information items that are retrieved from the authoritative source location via the network computing environment, or a link to the authoritative source location via the network computing environment. The ancillary storage device is a local device in circuit communication with the processing unit, or a remote device in communication with the processing unit via the network computing environment.

In another aspect, a computer program product has a tangible computer-readable storage medium with computer readable program code embodied therewith, the computer readable program code comprising instructions that, when executed by a computer processing unit, cause the computer processing unit to automatically collect information and notifications ancillary to the acquisition of a product or service. The processing unit determines transaction and information thresholds for application to attributes of a transaction for goods or services. The processing unit also identifies a card account used to purchase an item or service pursuant to the transaction and that is associated with application of the transaction and information thresholds. The processing unit determines additional informational items to be retained when the purchase of the item or service is accomplished, in response to an attribute of the additional informational items meeting the information threshold, an attribute of the transaction meeting the transaction threshold, and execution of the transaction via the identified card account. The processing unit identifies an authoritative source location for retrieval of copies of the additional information that has the attribute meeting the information threshold, wherein the authoritative source location is hosted by a remote device in communication with the processing unit via a network computing environment. The processing unit also identifies an ancillary storage device for holding copies of the additional information items that are retrieved from the authoritative source location via the network computing environment, or a link to the authoritative source location via the network computing environment. The ancillary storage device is a local device in circuit communication with the processing unit, or a remote device in communication with the processing unit via the network computing environment.

### BRIEF DESCRIPTION OF THE SEVERAL VIEWS OF THE DRAWINGS

These and other features of this invention will be more readily understood from the following detailed description of the various aspects of the invention taken in conjunction with the accompanying drawings in which:

FIG. 1 is a block diagram illustration of a method, system or process according to the present invention for the automated collection, notification and provision of information within a network computing environment that is ancillary to acquisition of a product or service.

FIG. 2 is a diagram illustration of aspects of a network computing environment according to the present invention that performs automated information collection and notification ancillary to the acquisition of a product or service.

FIG. 3 is a diagram illustration of other aspects of a network computing environment according to the present invention that performs automated information collection and notification ancillary to the acquisition of a product or service.

FIG. 4 is a block diagram illustration of a computer system implementation of an aspect of the present invention.

The drawings are not necessarily to scale. The drawings are merely schematic representations, not intended to portray specific parameters of the invention. The drawings are intended to depict only typical aspects, examples and embodiments of the invention, and therefore should not be considered as limiting the scope of the invention. In the drawings, like numbering represents like elements.

### DETAILED DESCRIPTION

It is generally desired to retain receipts, user manuals, warranty documents, and other ancillary documents associated with the sale of goods or services or other transactions for future use and reference. Tangible, printed versions of this information must be physically stored in files or other repositories that may be lost or difficult to find in the future. Further, ancillary information generated after a transaction (product recall notices, updates to manuals, specifications, requirements, warranty information, etc.) cannot generally be issued to an end user or consumer unless the end user/consumer takes steps to keep the appropriate issuer apprised of their current contact information (mailing address, email address, telephone number, etc.). This may problematic if the direct contact to the issuer is an intervening retailer or service provider, and the retail or service provider goes out of business, breaking an information connection to the end user.

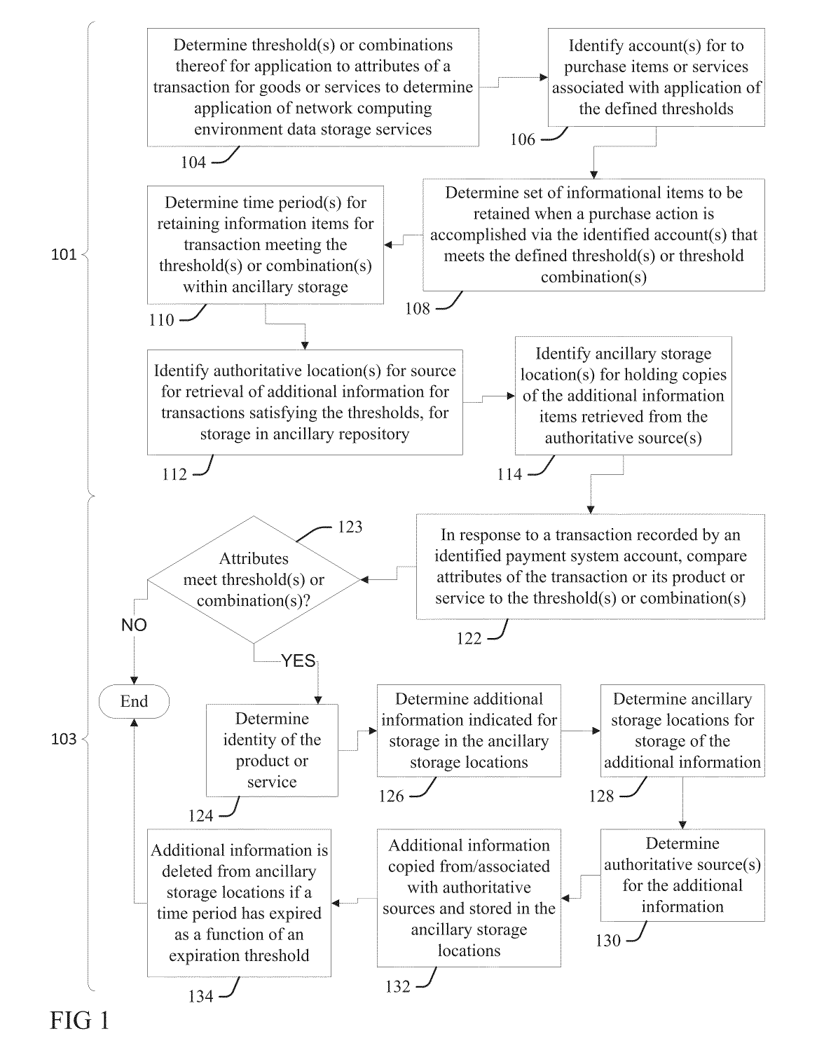

FIG. 1 illustrates a method, system or process according to the present invention for the automated collection, notification and provision of information within a network computing environment that is ancillary to acquisition of a product or service. In a preparation phase 101, at 104 a processing unit of a user or administrator determines one or more thresholds or combinations thereof for application to attributes of a transaction for goods or services to determine application of network computing environment data storage services according to the present invention. A network computing environment, which in some configurations may sometimes be referred to as a cloud computing environment, enables a plurality of different computer resources to interact cooperatively, abstracted (in some examples into a cloud layer) so that disparate devices appear to an end-user as a single pool of seamless resources. Examples of computer resources amenable to network computing or cloud environments include physical programmable devices (for example, servers, clients, etc.), storage and other memory devices, and logical computing applications and engines (for example, business and other software applications).

A wide variety of data may be associated with a given transaction, and an end user may engage in a large number of transactions. This may make storing all of the data associated with all of the transactions impractical, even within network computing environments providing pluralities of storage device accesses. Storing large amounts of data may also be of limited usefulness, as the user may find managing a large amount of data cumbersome and bothersome. Finding specific data within a large universe of data may also be more difficult or inefficient relative to searching a smaller, more selective data repository or plurality thereof.

Accordingly, thresholds are determined at 104 to limit transactions that are subject to archival data storage, or the amounts or types of data associated with any given transaction that are selected for archival storage. Thresholds include a minimum cost of an item or service transaction to trigger archival storage of data associated therewith, thereby excluding data from transactions of lessor value not worth tracking. A threshold type or category of item may also be defined; and in one aspect this and any other threshold may be used in context with other thresholds: for example, it may ensure that certain transactions are tracked regardless of value relative to the cost threshold (i.e. they are tracked even if they have a cost under the cost threshold), or that other transactions are always excluded (i.e. they are not tracked even if they have a cost over the cost threshold).

A threshold may be defined as a function of a physical location of a transaction, for example items purchased or used, or services provided, in one governmental subdivision (state, city, country, etc.) are to be acted upon, or are not to be acted upon. Thresholds also include type or category or name of retail merchant or service provider, for example items from a certain appliance store or retail business are tracked, while those from another store are disregarded. Thresholds also include type or category or data associated with an item or service of the transaction, for example certain types of recall notification or service bulletins, or those associated with designated items or items for a certain appliance store are tracked, while those from another store are disregarded. Still other thresholds appropriate for practicing the present invention will also be apparent to one skilled in the art.

At 106 the processing unit (via user or administrator specified or selected preference inputs or parameters) identifies one or more user credit card, loyalty card or other type of card or account which is used to purchase (lease, rent, retain, etc.) items or services associated with application of the thresholds defined at 104. At 108 the processing unit determines a set of informational items to be retained when the purchase action is accomplished that meet one or more of the thresholds or threshold combinations defined at 104 via the account(s) identified at 106, for example a copy of a warrantee or owner's manual for an item costing a threshold amount and purchased with a threshold card account. In some aspects of the invention, at 110 the processing unit determines one or more periods of time that certain information items for the transactions meeting the thresholds may be retained within ancillary storage. The time period may be specified or selected by a user or administrator, or it may be determined by rule, for example as a function of current available capacity, in order to age out older items and create space for new, incoming items.

At 112 the processing unit identifies one or more authoritative locations as sources for retrieval of copies of additional information for transaction satisfying the thresholds described above, for storage in an ancillary repository for future access. More particularly, in an operation phase (described below), a product/item/service transaction meeting the thresholds or combination of thresholds defined above at the time of purchase initiate the system or process to collect additional information about the product/item/service. Examples of the additional information items obtained from the authoritative source locations include charges and costs levied and paid; road usage tolls; carbon offset credits and debits; energy density of physical goods (for example, British Thermal Units (BTUs)-per-gallon, joules-per-cubic foot, etc.); manufacture information for a physical device or item purchased (for example, manufacture location, lot number, serial number; item usage directions and specifications information (for example, owner's manuals, application standards; warrantee information; service information (for example, location(s) of service providers or methods to obtain service); replacement part identification and procurement methods; and still other additional information items will be apparent to one skilled in the art.

Authoritative sources include a transaction interface that provides additional information items for repository storage contemporaneously with execution of the transaction, and external links and storage device addresses designated to hold such information as well as future, ancillary additional information (recall notices associated with the item purchased in the transaction, etc.).

At 114 the processing unit also identifies one or more ancillary storage locations for holding copies of the additional information items retrieved from the authoritative source locations; these may be secure locations distinguished from other, non-secure locations within one or more storage devices. In some aspects, the ancillary storage locations are generally accessible via the internet or other network access infrastructure, enabling a user or administrator to access the additional information items from a wide variety of platforms and locations. In other aspects, the ancillary storage locations are local devices, such as an individual personal computing system with limited or no public networking access.

In an operational phase 103 of aspects of the present invention, in response to a product or service purchase transaction recorded by a payment processing or loyalty system account identified at 106, at 122 attributes of the purchased product or service purchased or the transaction itself are compared to the thresholds or combinations determined at 104. In some aspects of the present invention, the processing unit identifies the product or service of the transaction by reading, scanning or recognizing input of a bar code identification, radio frequency identification (RFID) tag, serial number, device make and model, and still other identification indicia may be practiced and recognized at 122. In another aspect, the initial use of a product or associated information item by an end user or third party, for example to initiate or perform some designated action, may function as the trigger to initiate the attributes comparison at 122.

If the attributes meet the relevant thresholds or combinations at 123, at 124 an identity of the product or service of the transaction is determined; at 126 additional information (items or links) indicated for storage in the ancillary storage locations are determined (for example, those designated as relevant or selected by user or administrator preferences); at 128 ancillary storage locations are determined for the storage of the identified information items and links; and at 130 one or more authoritative sources are determined for the additional information identified at 126.

At 132, the additional information identified at 126 is copied from or associated with the authoritative sources as determined at 130 and stored in the ancillary storage locations as determined at 128. In some aspects, at 134 the identified additional information is compared to an expiration threshold determined at 104; if a time period has expired for retaining any of said information items or links as a function of the expiration threshold, the information items or links associated with the expired time period are deleted from (or not stored in) the determined ancillary storage locations.

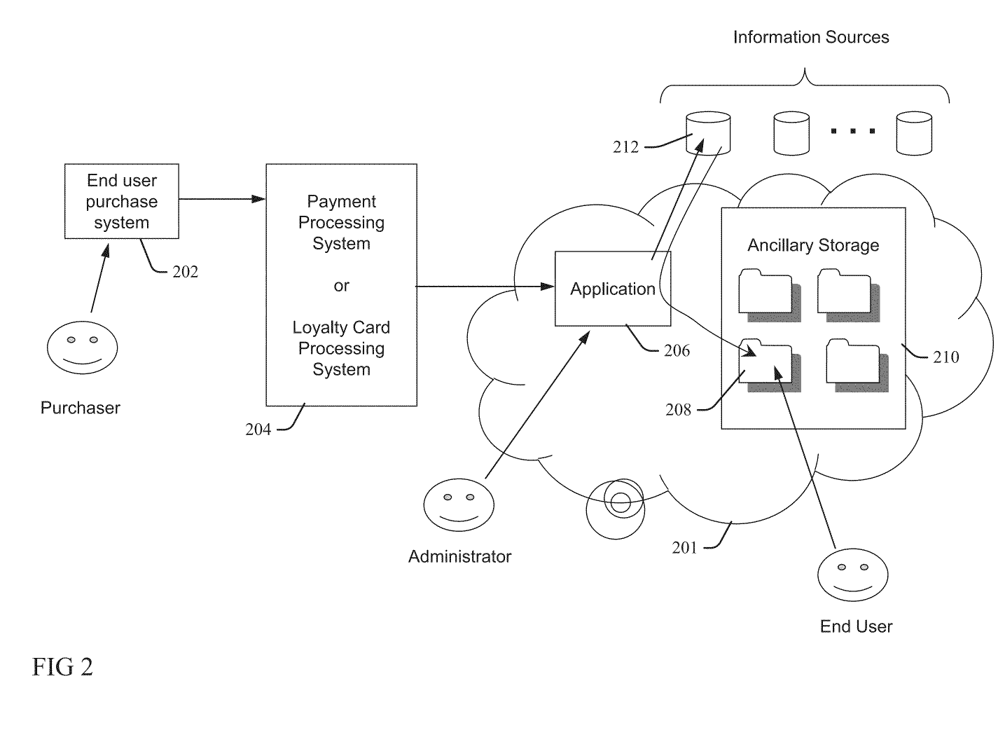

FIG. 2 illustrates an example of a cloud network computing environment 201 according to the method or system described above with respect to FIG. 1, and is described with respect to elements of FIG. 1. A purchaser executes via an end user purchase system interface 202 a transaction for an item purchase or services engagement by using a payment processing or system/loyalty card processing system 204 user account that is registered or identified (at 106, FIG. 1). In response to the transaction, a processing unit application 206 within the cloud 201 and under supervision of an administrator compares attributes of the purchased product or service purchased or the transaction itself to one or more thresholds (as determined at 104, FIG. 1). If the attributes meet the relevant threshold(s), the processing unit application 206 identifies additional information items and links indicated as relevant to the product or service and designated for storage in one or more designated folder locations 208 within a cloud ancillary storage device 210, determines which or one or more authoritative sources 212 have the additional information, selects the appropriate authoritative source(s) 212 and retrieves and stores the additional information, or links thereto, in the designated folder location(s) 208. Thus, an end user (which may be the purchaser of the administrator) may access the additional information from the folder location 208 in the future as necessary.

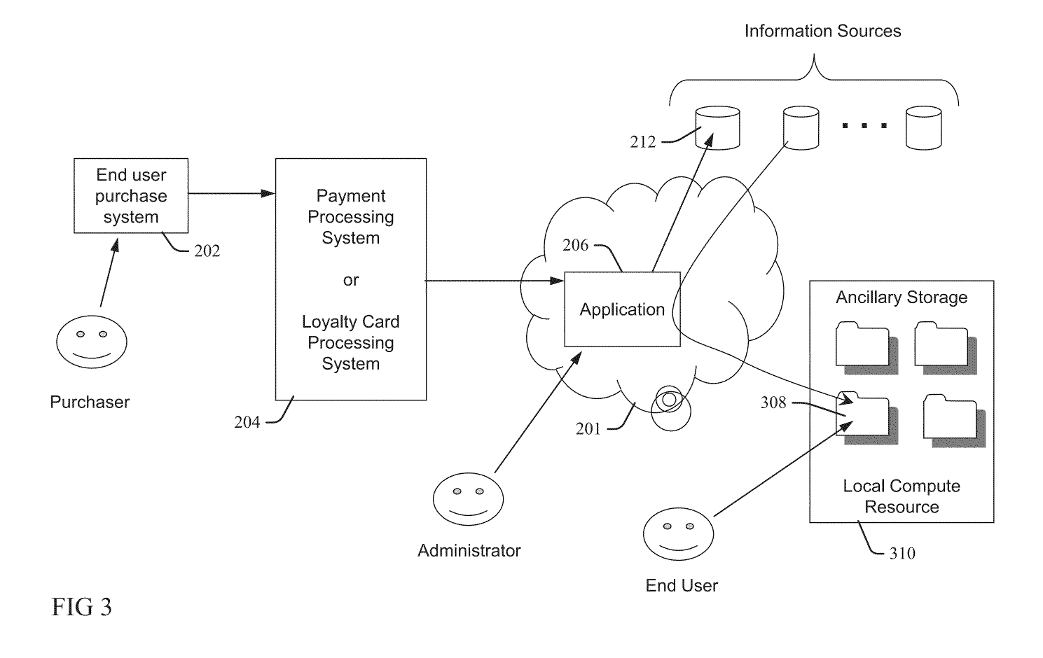

FIG. 3 illustrates another aspect of the present invention wherein folder locations 308 designated for storage of the additional information retrieved from the authoritative sources 212 are within a local computer resource storage device 310 that is outside of the cloud network computing environment 201, which may provide for access by an end user to the additional information without relying on operation of the cloud network computing environment 201, and may also provide for enhanced security by eliminating exposure of the folders 308 to other users via access options afforded to other users via the cloud network computing environment 201.

As will be appreciated by one skilled in the art, organizing the stored additional information items or links into folders 208/308 enables indexing, grouping and other organizing of the information that enables more rapid recall relative to generally stored data items. In one aspect, each major purchase transaction may have its own folder 208/308 in the ancillary storage devices 210/310. Within this folder 208/308 all information objects, including a transaction receipt, may be retained. The specific rendering of the folder 208/308 within a storage device 210/310 may be accomplished in a variety of fashions, and is generally dependent on the computing or operating system in which the folder 208/308 solution is implemented.

In some implementations of the process or system of FIG. 1 and FIG. 2 or FIG. 3, data is transferred into the folder 208/308 after a point of sale. For example, a purchaser purchases a car seat at a local discount store. At the time of checkout, the model and manufacturing date of the car seat is recorded and exchanged, wherein the purchaser has the information in a folder 208/308 on her smart phone 210/310, and the local discount store logs the sale on their central database. Four weeks later the manufacture of the car seat issues a recall on the car seat. The transfer of meta data as additional information (namely the brand, model, serial number and manufacture date) into the folder 208/308 enables multiple ways for the purchaser to become aware of the recall. In one, the manufacturer can notify the discount store, after which the discount store sends the purchaser a message via email, simple message service (SMS) text or chat, or via interpersonal communication next time the purchaser checks out at the store. In another, the manufacturer posts the recall to a public location authoritative source 212, wherein the purchaser's processing unit application 206 periodically checks the public authoritative source databases 212 for recall information matching identity indicia attribute of the product in the additional information stored in the folder 208/308 on the purchaser's phone 210/310, and when found copies the recall notice from the authoritative source 212 to the folder 208/308 as a function of the specific information that was received and saved or indexed on the smart phone folder 208/308 at the time of the sale.

Aspects of the inventions may assign a variety of differing responsibilities or tasks to purchasers, sellers, manufacturers, ends users, administrators, etc. In one example, the transaction is a purchase of a physical good wherein a seller's system application 206 identifies the good by RFID or barcode or serial number, etc., and causes an authoritative source 212 of the seller to broadcast nonphysical additional information relevant to the good on behalf of the seller for a defined period of time. A purchaser's computer system 210/310 communicates with seller's system authoritative source 212, which responds with the nonphysical information, and the purchaser's system 210/310 receives and stores the nonphysical, broadcast information into the purchaser's storage folder 208/308. The information flow is composed of the physical transport technology (for example, blue tooth, Wireless Fidelity (WiFi), universal serial bus (USB), and an appropriate information transfer protocol technology (for example, web services, etc.).

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in a baseband or as part of a carrier wave. Such a propagated signal may take any of a variety of forms, including, but not limited to, electro-magnetic or optical forms or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including, but not limited to, wireless, wire line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

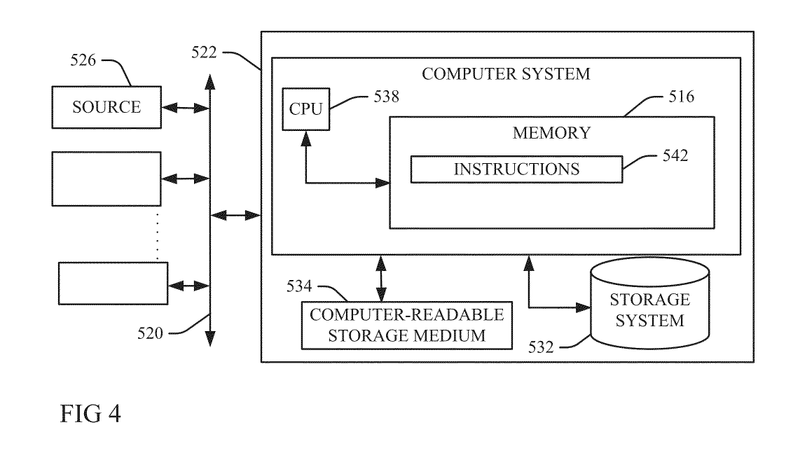

Referring now to FIG. 4, an exemplary computerized implementation of an aspect of the present invention includes a computer system or other programmable device 522 in communication with a plurality of information resources 526 (broadcasting devices, storage devices, servers, blogs, bulletin boards, etc.) that performs automated information collection and notification ancillary to the acquisition of a product or service as described above with respect to FIGS. 1, 2 and 3. Instructions 542 reside within computer readable code in a computer readable memory 516, or in a computer readable storage system 532, or other tangible computer readable storage medium 534 that is accessed through a computer network infrastructure 520 by a Central Processing Unit (CPU) 538. Thus, the instructions, when implemented by the processing unit 538, cause the processing unit 538 to perform automated information collection and notification ancillary to the acquisition of a product or service as described above with respect to FIGS. 1, 2 and 3.

In one aspect, the present invention may also perform process steps of the invention on a subscription, advertising, and/or fee basis. That is, a service provider could offer to integrate computer-readable program code into the computer system 522 to enable the computer system 522 to perform automated information collection and notification ancillary to the acquisition of a product or service as described above with respect to FIGS. 1, 2 and 3. The service provider can create, maintain, and support, etc., a computer infrastructure, such as the computer system 522, network environment 520, or parts thereof, that perform the process steps of the invention for one or more customers. In return, the service provider can receive payment from the customer(s) under a subscription and/or fee agreement and/or the service provider can receive payment from the sale of advertising content to one or more third parties. Services may include one or more of: (1) installing program code on a computing device, such as the computer device 522, from a tangible computer-readable medium device 532 or 534; (2) adding one or more computing devices to a computer infrastructure; and (3) incorporating and/or modifying one or more existing systems of the computer infrastructure to enable the computer infrastructure to perform the process steps of the invention.

The terminology used herein is for describing particular aspects only and is not intended to be limiting of the invention. As used herein, the singular forms “a”, “an” and “the” are intended to include the plural forms as well, unless the context clearly indicates otherwise. It will be further understood that the terms “include” and “including” when used in this specification, specify the presence of stated features, integers, steps, operations, elements, and/or components, but do not preclude the presence or addition of one or more other features, integers, steps, operations, elements, components, and/or groups thereof. Certain examples and elements described in the present specification, including in the claims and as illustrated in the figures, may be distinguished or otherwise identified from others by unique adjectives (e.g. a “first” element distinguished from another “second” or “third” of a plurality of elements, a “primary” distinguished from a “secondary” one or “another” item, etc.). Such identifying adjectives are generally used to reduce confusion or uncertainty, and are not to be construed to limit the claims to any specific illustrated element or embodiment, or to imply any precedence, ordering or ranking of any claim elements, limitations or process steps.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The aspect was chosen and described in order to best explain the principles of the invention and the practical application, and to enable others of ordinary skill in the art to understand the invention for various embodiments with various modifications as are suited to the particular use contemplated.

The flowchart and block diagrams in the figures illustrate the architecture, functionality, and operation of possible implementations of systems, methods and computer program products according to various aspects of the present invention. In this regard, each block in the flowchart or block diagrams may represent a module, segment, or portion of code, which includes one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for automated information collection and notification ancillary to the acquisition of a product or service, the method comprising:
a processing unit determining transaction and information thresholds for application to attributes of a transaction for goods or services;
the processing unit identifying a card account used to purchase an item or service pursuant to the transaction for goods or services and that is associated with application of the transaction and information thresholds;
the processing unit determining additional informational items to be retained when the purchase of the item or service is accomplished, in response to an attribute of the additional informational items meeting the information threshold, an attribute of the transaction meeting the transaction threshold, and execution of the transaction via the identified card account;
the processing unit identifying an authoritative source location for retrieval of copies of the additional information having the attribute meeting the information threshold, wherein the authoritative source location is hosted by a remote device in communication with the processing unit via a network computing environment; and
the processing unit identifying an ancillary storage device for holding at least one of the copies of the additional information items retrieved from the authoritative source location via the network computing environment, and a link to the authoritative source location via the network computing environment, wherein the ancillary storage device is a local device in circuit communication with the processing unit, or a remote device in communication with the processing unit via the network computing environment.

2. The method of claim 1, further comprising:
in response to a product or service purchase transaction recorded by the identified card account, the processing unit identifying an identity indicia attribute of the purchased product or service and comparing the identity indicia attribute and attributes of the recorded transaction to the transaction and information thresholds; and
in response to the identity indicia attribute and recorded transaction attributes meeting the transaction and information thresholds, the processing unit identifying an ancillary storage location on the ancillary storage device as a function of the identity indicia attribute and the recorded transaction attributes, and:
retrieving the additional information items from the authoritative source location via the network computing environment and copying the retrieved additional information items to the identified ancillary storage location on the ancillary storage device; or
storing the link to the authoritative source location via the network computing environment to the identified ancillary storage location on the ancillary storage device.

3. The method of claim 2, further comprising:
the processing unit periodically checking the additional information items on the authoritative source location via the network computing environment for recall information matching the identity indicia attribute of the purchased product or service; and
the processing unit copying the recall information matching the identity indicia attribute of the purchased product or service from the authoritative source location to the identified ancillary storage location in response to the periodically checking for the recall information and finding the recall information on the authoritative source location.

4. The method of claim 2, further comprising:
the processing unit determining a period of time that a certain item of the additional informational items is retained within the ancillary storage; and
the processing unit deleting the certain item in response to the certain item being aged out as a function of a time period threshold.

5. The method of claim 2, wherein the network computing environment is a cloud computing environment.

6. The method of claim 2, wherein the transaction thresholds comprise a minimum cost threshold for the transaction for the product or service that must be met to trigger the steps of retrieving and storing in the identified ancillary storage location the additional information or the link to the authoritative source location.

7. The method of claim 6, wherein the transaction thresholds comprise a threshold type or category of the product; and
wherein the processing unit retrieves the additional information items from the authoritative source location via the network computing environment and copies the retrieved additional information items to the identified ancillary storage location on the ancillary storage device, or stores the link to the authoritative source location via the network computing environment to the identified ancillary storage location on the ancillary storage device, in response to the purchased product identity indicia attribute meeting the threshold type or category of the product; and
wherein the processing unit does not retrieve the additional information items from the authoritative source location via the network computing environment and copy the retrieved additional information items to the identified ancillary storage location on the ancillary storage device, or does not store the link to the authoritative source location via the network computing environment to the identified ancillary storage location on the ancillary storage device, in response to the purchased product identity indicia attribute not meeting the threshold type or category of the product.

8. A method for automated information collection and notification ancillary to the acquisition of a product or service, the method comprising:
integrating computer-readable program code into a computer system comprising a processing unit, a computer readable memory and a computer readable tangible storage medium, wherein the computer readable program code is embodied on the computer readable tangible storage medium and comprises instructions that, when executed by the processing unit via the computer readable memory, cause the processing unit to perform steps of:
determining transaction and information thresholds for application to attributes of a transaction for goods or services;
identifying a card account used to purchase an item or service pursuant to the transaction for goods or services and that is associated with application of the transaction and information thresholds;
determining additional informational items to be retained when the purchase of the item or service is accomplished, in response to an attribute of the additional informational items meeting the information threshold, an attribute of the transaction meeting the transaction threshold, and execution of the transaction via the identified card account;
identifying an authoritative source location for retrieval of copies of the additional information having the attribute meeting the information threshold, wherein the authoritative source location is hosted by a remote device in communication with the processing unit via a network computing environment; and
identifying an ancillary storage device for holding at least one of the copies of the additional information items retrieved from the authoritative source location via the network computing environment, and a link to the authoritative source location via the network computing environment, wherein the ancillary storage device is a local device in circuit communication with the processing unit, or a remote device in communication with the processing unit via the network computing environment.

9. The method of claim 8, further comprising;
the processing unit, when executing the program instructions stored on the tangible computer-readable storage medium via the computer readable memory:
in response to a product or service purchase transaction recorded by the identified card account, identifying an identity indicia attribute of the purchased product or service and comparing the identity indicia attribute and attributes of the recorded transaction to the transaction and information thresholds; and
in response to the identity indicia attribute and recorded transaction attributes meeting the transaction and information thresholds, identifying an ancillary storage location on the ancillary storage device as a function of the identity indicia attribute and the recorded transaction attributes, and:
retrieving the additional information items from the authoritative source location via the network computing environment and copying the retrieved additional information items to the identified ancillary storage location on the ancillary storage device; or
storing the link to the authoritative source location via the network computing environment to the identified ancillary storage location on the ancillary storage device.

10. The method of claim 9, further comprising:
the processing unit, when executing the program instructions stored on the tangible computer-readable storage medium via the computer readable memory:
periodically checking the additional information items on the authoritative source location via the network computing environment for recall information matching the identity indicia attribute of the purchased product or service; and
copying the recall information matching the identity indicia attribute of the purchased product or service from the authoritative source location to the identified ancillary storage location in response to the periodically checking for the recall information and finding the recall information on the authoritative source location.

11. The method of claim 9, wherein the transaction thresholds comprise a minimum cost threshold for the transaction for the product or service that must be met to trigger the steps of retrieving and storing in the identified ancillary storage location the additional information or the link to the authoritative source location;
wherein the transaction thresholds comprise a threshold type or category of the product; and
wherein the processing unit retrieves the additional information items from the authoritative source location via the network computing environment and copies the retrieved additional information items to the identified ancillary storage location on the ancillary storage device, or stores the link to the authoritative source location via the network computing environment to the identified ancillary storage location on the ancillary storage device, in response to the purchased product identity indicia attribute meeting the threshold type or category of the product; and
the processing unit, when executing the program instructions stored on the tangible computer-readable storage medium via the computer readable memory, in response to the purchased product identity indicia attribute not meeting the threshold type or category of the product, not retrieving the additional information items from the authoritative source location via the network computing environment and copying the retrieved additional information items to the identified ancillary storage location on the ancillary storage device, or not storing the link to the authoritative source location via the network computing environment to the identified ancillary storage location on the ancillary storage device.

12. A system, comprising:
a processing unit in communication with a computer readable memory and a tangible computer-readable storage medium;
wherein the processing unit, when executing program instructions stored on the tangible computer-readable storage medium via the computer readable memory:
determines transaction and information thresholds for application to attributes of a transaction for goods or services;
identifies a card account used to purchase an item or service pursuant to the transaction for goods or services and that is associated with application of the transaction and information thresholds;
determines additional informational items to be retained when the purchase of the item or service is accomplished, in response to an attribute of the additional informational items meeting the information threshold, an attribute of the transaction meeting the transaction threshold, and execution of the transaction via the identified card account;
identifies an authoritative source location for retrieval of copies of the additional information having the attribute meeting the information threshold, wherein the authoritative source location is hosted by a remote device in communication with the processing unit via a network computing environment; and
identifies an ancillary storage device for holding at least one of the copies of the additional information items retrieved from the authoritative source location via the network computing environment, and a link to the authoritative source location via the network computing environment, wherein the ancillary storage device is a local device in circuit communication with the processing unit, or a remote device in communication with the processing unit via the network computing environment.

13. The system of claim 12, wherein the processing unit, when executing the program instructions stored on the computer-readable storage medium via the computer readable memory, further:
in response to a product or service purchase transaction recorded by the identified card account, identifies an identity indicia attribute of the purchased product or service and compares the identity indicia attribute and attributes of the recorded transaction to the transaction and information thresholds; and
in response to the identity indicia attribute and recorded transaction attributes meeting the transaction and information thresholds, identifies an ancillary storage location on the ancillary storage device as a function of the identity indicia attribute and the recorded transaction attributes, and:
retrieves the additional information items from the authoritative source location via the network computing environment and copies the retrieved additional information items to the identified ancillary storage location on the ancillary storage device; or
stores the link to the authoritative source location via the network computing environment to the identified ancillary storage location on the ancillary storage device.

14. The system of claim 12, wherein the processing unit, when executing the program instructions stored on the computer-readable storage medium via the computer readable memory, further:
periodically checks the additional information items on the authoritative source location via the network computing environment for recall information matching the identity indicia attribute of the purchased product or service; and
copies the recall information matching the identity indicia attribute of the purchased product or service from the authoritative source location to the identified ancillary storage location in response to the periodical check for the recall information and finding the recall information on the authoritative source location.

15. The system of claim 12, wherein the processing unit, when executing the program instructions stored on the computer-readable storage medium via the computer readable memory, further:
determines a period of time that a certain item of the additional informational items is retained within the ancillary storage; and
deletes the certain item in response to the certain item being aged out as a function of a time period threshold.

16. The system of claim 12, wherein the network computing environment is a cloud computing environment.

17. The system of claim 12, wherein the transaction thresholds comprise a minimum cost threshold for the transaction for the product or service; and
wherein the processing unit, when executing the program instructions stored on the computer-readable storage medium via the computer readable memory, further:
retrieves the additional information items from the authoritative source location via the network computing environment and copies the retrieved additional information items to the identified ancillary storage location on the ancillary storage device, or stores the link to the authoritative source location via the network computing environment to the identified ancillary storage location on the ancillary storage device, in response to a cost of the transaction for the product or service meeting the minimum cost threshold; and
does not retrieve the additional information items from the authoritative source location via the network computing environment and copy the retrieved additional information items to the identified ancillary storage location on the ancillary storage device, or does not store the link to the authoritative source location via the network computing environment to the identified ancillary storage location on the ancillary storage device, in response to the cost of the transaction for the product or service not meeting the minimum cost threshold.

18. The system of claim 17, wherein the transaction thresholds comprise a threshold type or category of the product; and
wherein the processing unit, when executing the program instructions stored on the computer-readable storage medium via the computer readable memory, further:
retrieves the additional information items from the authoritative source location via the network computing environment and copies the retrieved additional information items to the identified ancillary storage location on the ancillary storage device, or stores the link to the authoritative source location via the network computing environment to the identified ancillary storage location on the ancillary storage device, in response to the purchased product identity indicia attribute meeting the threshold type or category of the product; and
does not retrieve the additional information items from the authoritative source location via the network computing environment and copy the retrieved additional information items to the identified ancillary storage location on the ancillary storage device, or store the link to the authoritative source location via the network computing environment to the identified ancillary storage location on the ancillary storage device, in response to the purchased product identity indicia attribute not meeting the threshold type or category of the product.

19. A computer program product for automated information collection and notification ancillary to the acquisition of a product or service, the computer program product comprising:
a computer readable tangible storage medium having computer readable program code embodied therewith, the computer readable program code comprising instructions that, when executed by a computer processing unit, cause the computer processing unit to:
determine transaction and information thresholds for application to attributes of a transaction for goods or services;
identify a card account used to purchase an item or service pursuant to the transaction for goods or services and that is associated with application of the transaction and information thresholds;
determine additional informational items to be retained when the purchase of the item or service is accomplished, in response to an attribute of the additional informational items meeting the information threshold, an attribute of the transaction meeting the transaction threshold, and execution of the transaction via the identified card account;
identify an authoritative source location for retrieval of copies of the additional information having the attribute meeting the information threshold, wherein the authoritative source location is hosted by a remote device in communication with the processing unit via a network computing environment; and
identify an ancillary storage device for holding at least one of the copies of the additional information items retrieved from the authoritative source location via the network computing environment, and a link to the authoritative source location via the network computing environment, wherein the ancillary storage device is a local device in circuit communication with the processing unit, or a remote device in communication with the processing unit via the network computing environment.

20. The computer program product of claim 19, wherein the computer readable program code instructions, when executed by the computer processing unit, further cause the computer processing unit to:
in response to a product or service purchase transaction recorded by the identified card account, identify an identity indicia attribute of the purchased product or service and compare the identity indicia attribute and attributes of the recorded transaction to the transaction and information thresholds; and
in response to the identity indicia attribute and recorded transaction attributes meeting the transaction and information thresholds, identify an ancillary storage location on the ancillary storage device as a function of the identity indicia attribute and the recorded transaction attributes, and:
retrieve the additional information items from the authoritative source location via the network computing environment and copy the retrieved additional information items to the identified ancillary storage location on the ancillary storage device; or
store the link to the authoritative source location via the network computing environment to the identified ancillary storage location on the ancillary storage device.

21. The computer program product of claim 19, wherein the computer readable program code instructions, when executed by the computer processing unit, further cause the computer processing unit to:
periodically check the additional information items on the authoritative source location via the network computing environment for recall information matching the identity indicia attribute of the purchased product or service; and
copy the recall information matching the identity indicia attribute of the purchased product or service from the authoritative source location to the identified ancillary storage location in response to the periodical check for the recall information finding the recall information on the authoritative source location.

22. The computer program product of claim 19, wherein the transaction thresholds comprise a minimum cost threshold for the transaction for the product or service; and
wherein the computer readable program code instructions, when executed by the computer processing unit, further cause the computer processing unit to:
retrieve the additional information items from the authoritative source location via the network computing environment and copy the retrieved additional information items to the identified ancillary storage location on the ancillary storage device, or store the link to the authoritative source location via the network computing environment to the identified ancillary storage location on the ancillary storage device, in response to a cost of the transaction for the product or service meeting the minimum cost threshold; and
not retrieve the additional information items from the authoritative source location via the network computing environment and copy the retrieved additional information items to the identified ancillary storage location on the ancillary storage device, or not store the link to the authoritative source location via the network computing environment to the identified ancillary storage location on the ancillary storage device, in response to the cost of the transaction for the product or service not meeting the minimum cost threshold.

23. The computer program product of claim 22, wherein the transaction thresholds comprise a threshold type or category of the product; and
wherein the computer readable program code instructions, when executed by the computer processing unit, further cause the computer processing unit to:
retrieve the additional information items from the authoritative source location via the network computing environment and copy the retrieved additional information items to the identified ancillary storage location on the ancillary storage device, or store the link to the authoritative source location via the network computing environment to the identified ancillary storage location on the ancillary storage device, in response to the purchased product identity indicia attribute meeting the threshold type or category of the product; and
not retrieve the additional information items from the authoritative source location via the network computing environment and copy the retrieved additional information items to the identified ancillary storage location on the ancillary storage device, or not store the link to the authoritative source location via the network computing environment to the identified ancillary storage location on the ancillary storage device, in response to the purchased product identity indicia attribute not meeting the threshold type or category of the product.
